(19) United States
(12) Patent Application Publication
(10) Pub. No.: US 2006/0021228 A1
(43) Pub. Date: Feb. 2, 2006

(54) Dry shaver

(75) Inventors: Takeshi Shiba, Hikone-shi (JP); Toshiyuki Tsushio, Hikone-shi (JP); Masanobu Yamasaki, Hikone-shi (JP); Jyuzaemon Iwasaki, Nagahama-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: MATSUSHITA ELECTRIC WORKS, LTD.

(21) Appl. No.: 11/189,854

(22) Filed: Jul. 27, 2005

(30) Foreign Application Priority Data
Jul. 30, 2004 (JP) 2004-224478

(51) Int. Cl. B26B 19/02

(52) U.S. Cl. 30/43.92

(57) ABSTRACT

A dry shaver includes a hand grip and a shaving head supported to the grip. The shaving head carries a foil cutter unit composed of an outer foil and an inner cutter driven to move relative to the outer foil in hair shearing engagement therewith. The outer foil is elongated to have a length and a width, and is arcuately curved along its length. The shaving head is movably supported to the grip so as to be tiltable about a transverse axis parallel to the width of the outer foil. Thus, when the shaving head is pressed against the skin as being inclined, the shaving head is allowed to tilt in a direction of reducing a contact pressure which would otherwise be greater at one longitudinal end than at the other longitudinal end. Therefore, the shaving head can be free from undue dragging at either of the longitudinal ends of the outer foil to be thereby guided smoothly across the skin surface for efficient and comfortable shaving.

### TECHNICAL FIELD

The present invention is directed to a dry shaver having an arcuately curved cutter unit.

### BACKGROUND ART

Japanese Patent Publication (KOKOKU) No. 57-53748 discloses a dry shaver having an arcutately curved cutter unit composed of a curved outer perforated foil and a correspondingly shaped inner cutter. The outer foil Is curved arcuately along its lengthwise direction for the purpose of giving a smooth fit on curves skin areas, particularly a concave skin area, for example, the lower jaw. The outer foil is formed at its longitudinal ends with resilient legs by which the outer foil is supported to a shaving head so as to be capable of being depressed at either of the longitudinal ends. When the shaving head is moving across the skin as being inclined thereto, i.e., with the outer foil being pressed at one of the longitudinal ends at a force stronger than at the other longitudinal end, the one longitudinal end of the outer foil gives a greater resistance to impede smooth movement of the shaving head. Therefore, there is a demand for smoothly moving the shaving head, while maintaining the advantageous function of the arcuately curved outer foil.

### DISCLOSURE OF THE INVENTION

In view of the above problem, the present invention has been accomplished to provide an improved dry shaver which is capable of being smoothly guided across a user's skin. The dry shaver in accordance with the present invention includes a grip to be grasped by a user's hand, and a shaving head being supported to the grip. The shaving head carries a foil cutter unit composed of an outer foil having a plurality of perforations and an inner cutter driven to move relative to the outer foil in hair shearing engagement therewith. The outer foil is elongated to have a length and a width, and is arcuately curved along its length. The feature of the present invention resides in that the shaving head is movably supported to the grip so as to be tiltable about a transverse axis parallel to the width of the outer foil. Thus, when the shaving head is pressed against the skin as being inclined, the shaving head is allowed to tilt in a direction of reducing a contact pressure which would otherwise be greater at one longitudinal end than at the other longitudinal end. Therefore, the shaving head can be free from undue dragging at either of the longitudinal ends of the outer foil to be thereby guided smoothly across the skin surface for efficient and comfortable shaving.

Preferably, the shaving head accommodates therein a motor for driving the inner cutter so as to complete the driving connection within the shaving head, which is advantageous for easy fabrication of the dry shaver.

Further, the shaving head is preferred to be floatingly supported to the grip so as to be capable of being depressed. The depressing movement is combined with the tilting movement of the shaving head to assure an optimum contact between the outer foil and the skin over various portion of the skin.

In a preferred embodiment, the shaving head is configured to have a pair of the foil cutter units, and to be inclined with respect to a height axis of the grip to have a front upper end and a rear upper end at a lever higher than the front upper end. One of the cutter units is located at the front upper end, and the other cutter unit at the rear upper end so that the cutter units at the front upper end comes first into contact with the skin in a normal use of the shaver. In this instance, the cutter unit at the front upper end is biased upwardly by a less spring bias than the cutter unit at the rear upper end. With this arrangement, the cutter unit at the front end can be depressed by a greater extent that the cutter unit at the rear end, thereby facilitating to bring the both cutter unit into simultaneous contact with the skin for efficient shaving.

Further, the shaving head may include a slit cutter which is interposed between the foil cutter units and is biased upwardly by a spring bias which is equal or less than that of the foil cutter unit at the front upper end of the shaving head. Thus, the slit cutter unit can be easy to come into contact with the skin simultaneously with the foil cutter units.

The slit cutter unit is arranged in parallel with the foil cutter unit and includes an outer slit cutter which is also curved arcuately along its length. The outer slit cutter may be configured to have a radius of curvature which is greater than that of the outer foil. Thus, the outer slit cutter can come into contact with the skin over a wider range than the arcuately curved outer foil, reducing a possibility that the outer foil is pressed against the skin excessively for optimum and comfortable contact with the skin.

The shaving head may be formed on its upper face with shoulders respectively in closely adjacent relation to the longitudinal ends of the outer foil for sliding contact with a user's skin. Each of the shoulders is rounded at its corner away from the outer foil to give a curved corner having a radius of curvature of 2 mm to 10 mm for smooth and safe contact with the skin during the manipulation of moving the shaving head across the user's skin.

In this connection, the shoulders are finished to have minute smooth irregularities which give a nonglossy finish while retaining smooth sliding contact with the skin. The nonglossy finish can hide or make inconspicuous any scratch inevitably developed around the outer foil by repeated contact with the hairs during the long term use.

For the same purpose, the shaving head is formed in its top surface with a frill which is given a nonglossy finish. The frill extends along the periphery of the outer foil including the shoulders.

Further, the shaving head may be suspended to the grip by use of a specific linkage mechanism so as to be capable of tilting smoothly while keeping an optimum contact relation with the skin. For this purpose, the shaving head having a pair of support points through which the shaving head is supported to the grip. The linkage mechanism allows the shaving head to swing relative to the grip, and includes a pair of cranks each connected at its one end to each one of the support points and connected at the other end to each one of anchor points on the side of the grip. A frame is provided to project on top of the grip in an overlapping relation with the shaving head to give the anchor points (A) which are positioned upwardly of the support point (S) with respect to the height axis of the grip, thereby suspending the shaving head by the frame. With the employment of the above linkage mechanism, the shaving head can swing only accompanied with a small vertical displacement of its top cutting face from the skin, but with a sufficient angular displacement of the cranks about the anchor points, thereby keeping an optimum contacting pressure against the skin, yet swinging the shaving head to smoothly follow the skin, all of which assure a comfortable and effective shaving performance.

These and still other advantageous features of the present invention will become more apparent from the following detailed description of the preferred embodiment when taken in conjunction with the attached drawings.

### BRIEF DESCRIPTION OF THE DRAWINGS

FIG. 1 is a perspective view of a dry shaver in accordance with a preferred embodiment of the present invention;

FIG. 2 is an exploded perspective view of the dry shaver;

FIG. 3 is a front view of the dry shaver;

FIG. 4 is a side view of the dry shaver;

FIG. 5 is a vertical front section of the dry shaver;

FIG. 6 is a vertical side section of the dry shaver;

FIG. 7 is an exploded perspective view of a cutter holder utilized in the above shaver;

FIG. 8 is an exploded perspective view of a shaving head of the shaver;

FIG. 9 is a perspective view of a slit cutter unit included in the shaving head;

FIG. 10 is an exploded perspective view of the slit cutter unit;

FIG. 11 is an exploded perspective view of a linking mechanism for coupling the shaving head to a grip of the shaver;

FIG. 12 is an exploded perspective view of the linking mechanism and the shaving head;

FIGS. 13 to 16 are schematic views respectively illustrating the shaving head in different operating positions; and

FIGS. 17 and 18 are schematic views demonstrating the characteristic swinging movement of the present invention in contrast to another possible arrangement.

### BEST MODE FOR CARRYING OUT THE INVENTION

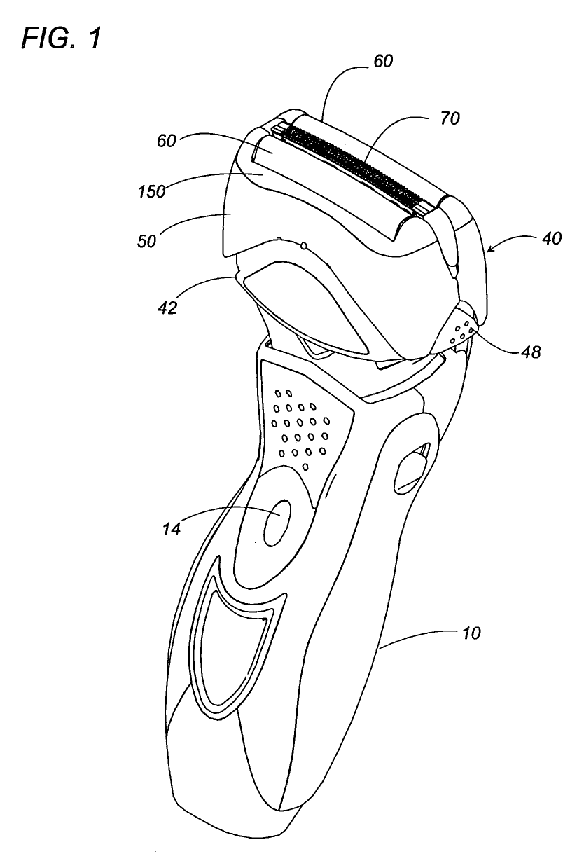

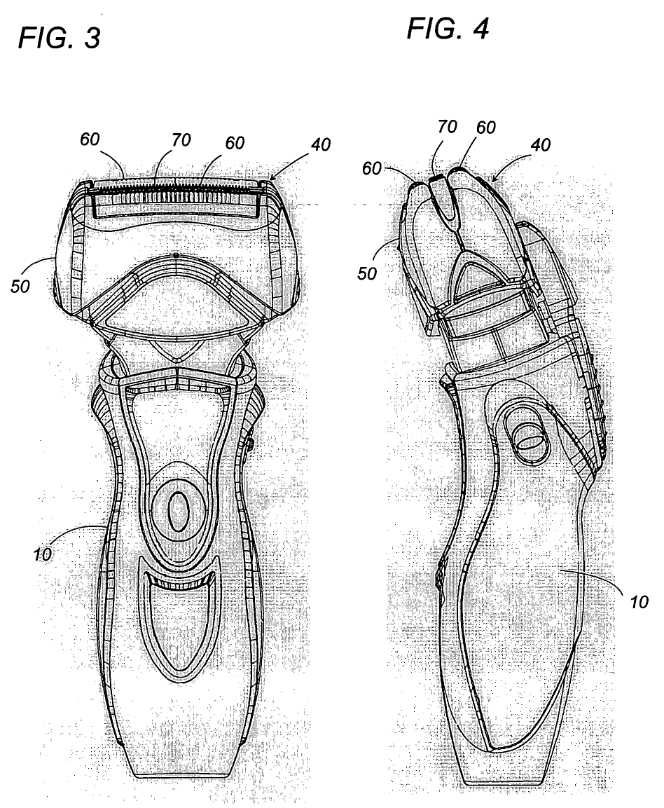

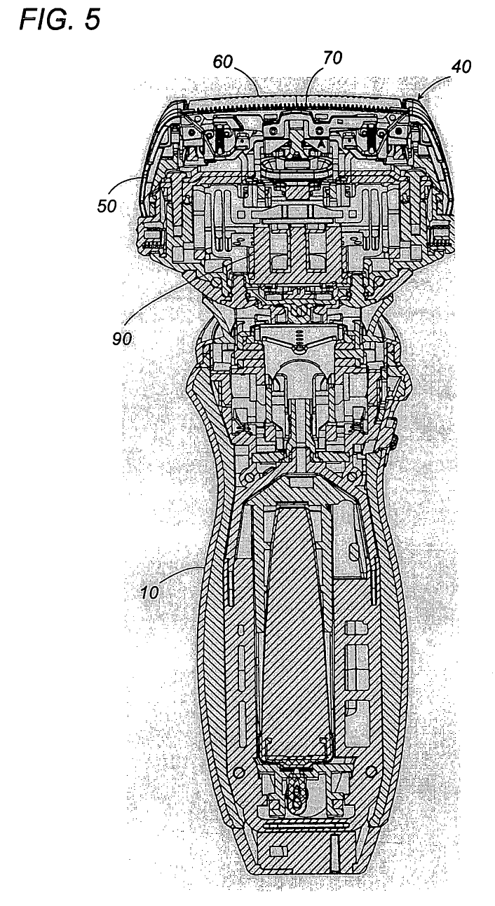

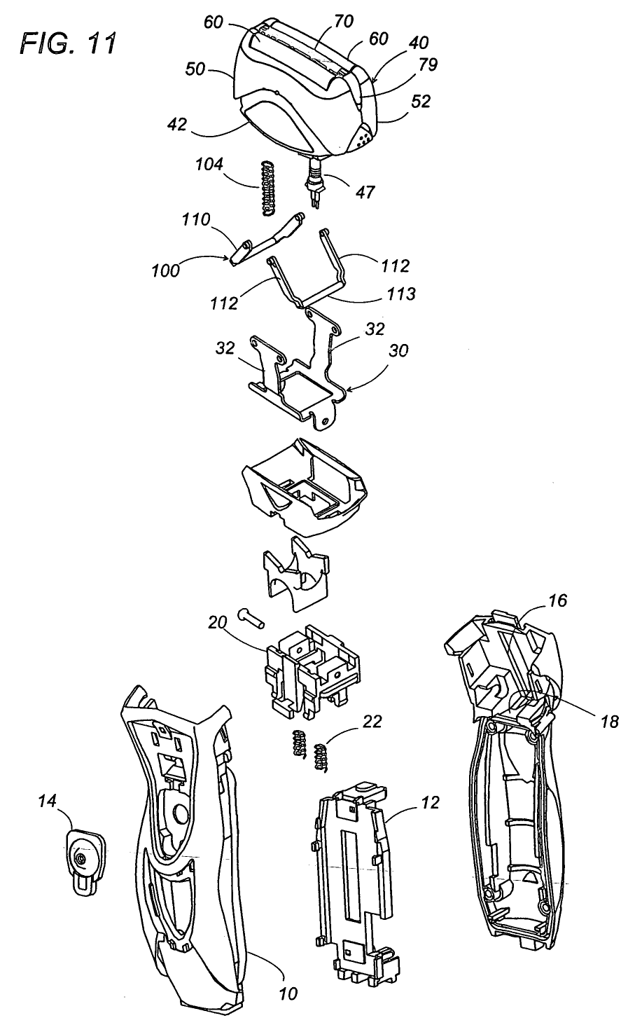

Referring now to FIGS. 1 to 6, there is shown a dry shaver in accordance with a preferred embodiment of the present invention. The shaver is basically composed of an elongated grip 10 with a height axis shaped to be grasped by a user' hand, and a shaving head 40 mounted on top of the grip 10 to be swingable relative thereto. The grip 10 accommodates therein a chassis 12 carrying electronic components forming a power supply and a switch actuated by a button 14 on the exterior of the grip 10, as shown in FIG. 11. Formed in the upper end of the grip 10 is a top-opened cavity 16 with a closed bottom 18 for receiving therein a slider 20 which carries a frame 30 supporting the shaving head 40. The slider 20 is slidable along the height axis and is biased upwardly by springs 22 interposed between the lower end of the slider and the bottom 18 of the cavity 16 for floatingly supporting the shaving head 40 on top of the grip 10. The frame 30 projects on top of the grip 10 and includes a pair of props 32 which are spaced in a thickness direction of the grip 10 for connection to front and rear ends of the shaving head 40 by means of a linkage mechanism 100 by which the shaving head 40 is allowed to swing relative to the grip 10 about a swing axis running in the thickness direction of the shaving head 40, as will be explained in detail.

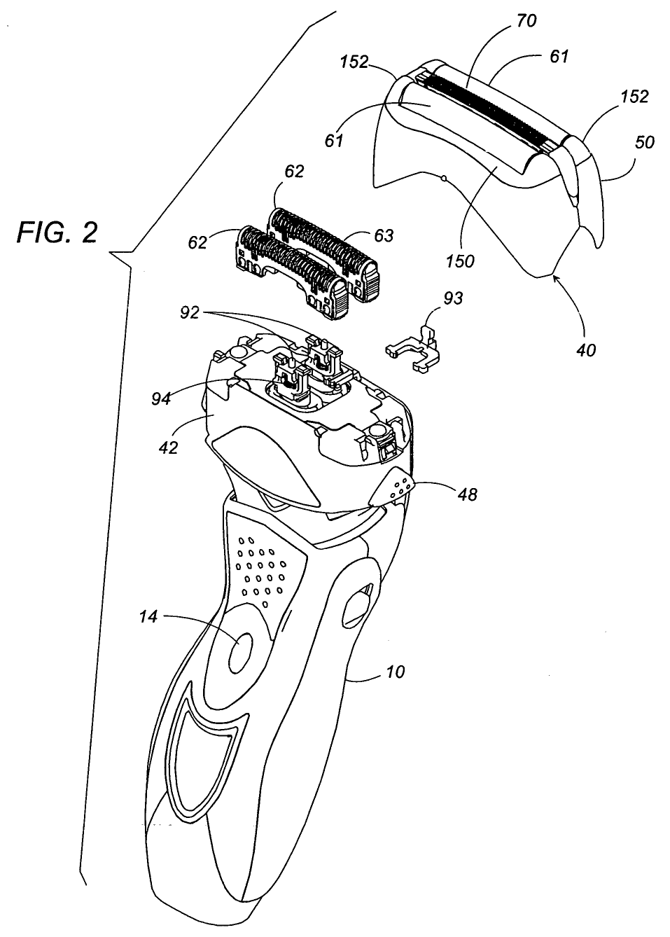

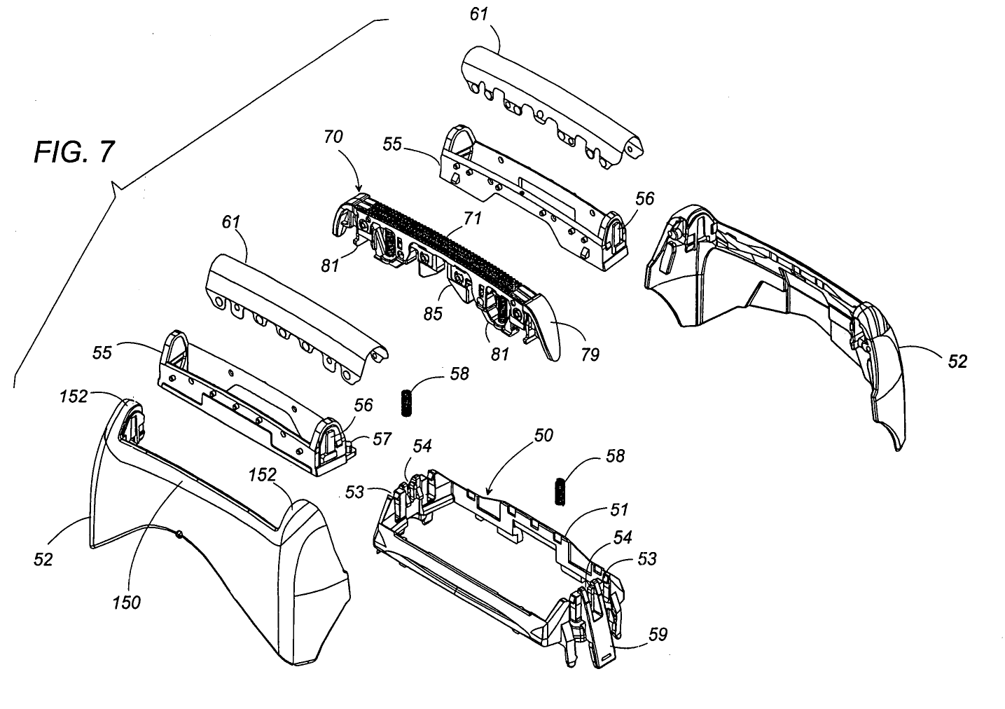

As best shown in FIG. 4, the shaving head 40 is inclined with respect to the height axis of the grip 10 to have a front upper end and a rear upper end at a level higher than the front upper end. The shaving head 40 is elongated to have a lengthwise axis and carries two foil cutter units 60 and a slit cutter unit 70. The foil cutter units 60 are disposed respectively on the front and rear upper ends of the shaver head in parallel relation with each other, while the slit cutter unit 70 is interposed between the foil cutter units 60. Each foil cutter unit 60 is designed for shaving relatively short hairs, and includes an outer foil 61 with a plurality of perforations and an associated inner cutter 62 composed of a plurality of arcuate blades 63. The outer foil 61 is shaped to have a generally U-shaped section and is curved arcuately along its length. The slit cutter unit 70 is designed for shaving relatively long hairs, and includes an elongated outer straight cutter 71 with a plurality of slits and an inner cutter 72. Also included in the shaving head 40 is a cradle case 42 which mounts a detachable cutter holder 50 carrying the two outer arcuate foils 61 and the slit cutter unit 70, as best shown in FIGS. 2 and 7. The inner cutters 62 and 72 are driven by a motor 90 to reciprocate relative to the outer arcuate foils 61 and outer straight cutter 71. Release buttons 48 are provided on opposite ends of the cradle case 42 for releasably holding the cutter holder 50. The cradle case 42 is configured to accommodate therein the motor 90 with two output elements 92 which project on top of the cradle case 42 for connection with the inner cutters 62. A pin 93 is secured to one of the output elements 92 and is detachably connected to the inner cutter 72 of the slit cutter unit 70 for reciprocating the same. The case 42 has its top opening closed by a plate 46 through which the output element 92 extend for detachable connection with the inner cutters 62. The outer foils 61 and the outer slit cutter 71 are exposed on top of the shaving head 40 to give a general cutting face for contact with a user's skin. A flexible tube 47 extends from the bottom of the cradle case 42 through the frame 30, the slider 20 and through the bottom 18 of the cavity 16 to seal leads which feeds a current from the power supply to the motor 90. Upon being energized, the motor 90 drives the inner cutters to reciprocate for hair shaving.

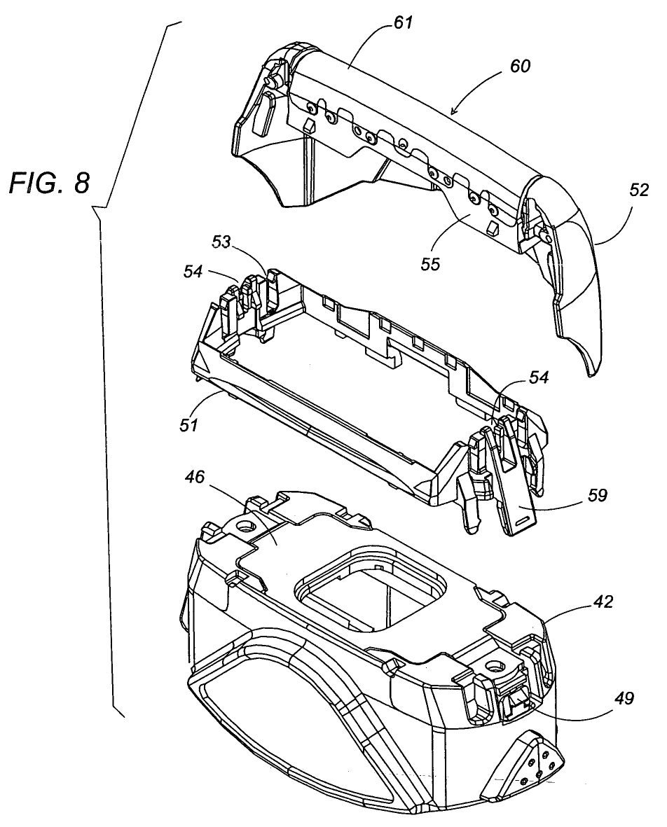

As shown in FIGS. 7 and 8, the cutter holder 50 includes a rectangular frame 51 which supports a pair of cassettes 55 each carrying the foils 61 of the foil cutter unit 60, in addition to the slit cutter unit 70. The frame 51 is detachably mounted to the upper end of the cradle case 42 to be unmovably secured thereto by engagement of hooks 59 at the longitudinal ends of the frame 51 with corresponding catches 49 on the upper end of the cradle case 42. Each cassette 55 is formed at its longitudinal ends respectively with studs 56 which are slidably received in vertical slots 53 in the longitudinal ends of the frame 51 so that the cassette 55 or the outer foil 61 carried thereon is movable at either longitudinal ends relative to the frame 51 and therefore the cradle case 42 so that the outer foil 61 is capable of being depressed and even inclined with respect to the width axis of the cradle case 42. A cover 52 is fixed to each cassette 55 to be movable therewith in relation to the frame 51 or the cradle case 42, and conceal a major portion of the cradle case 42 therebehind.

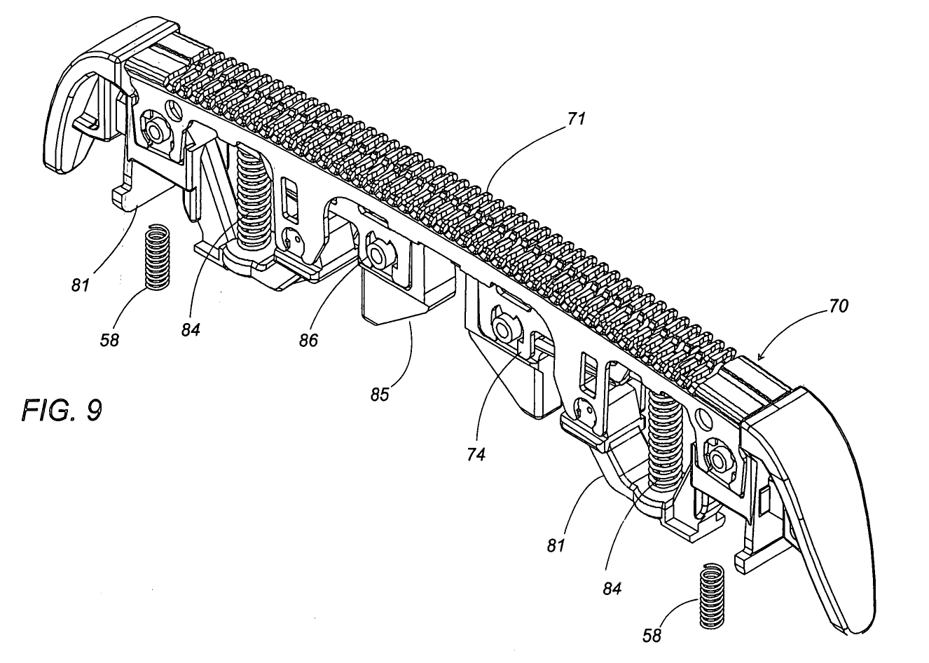

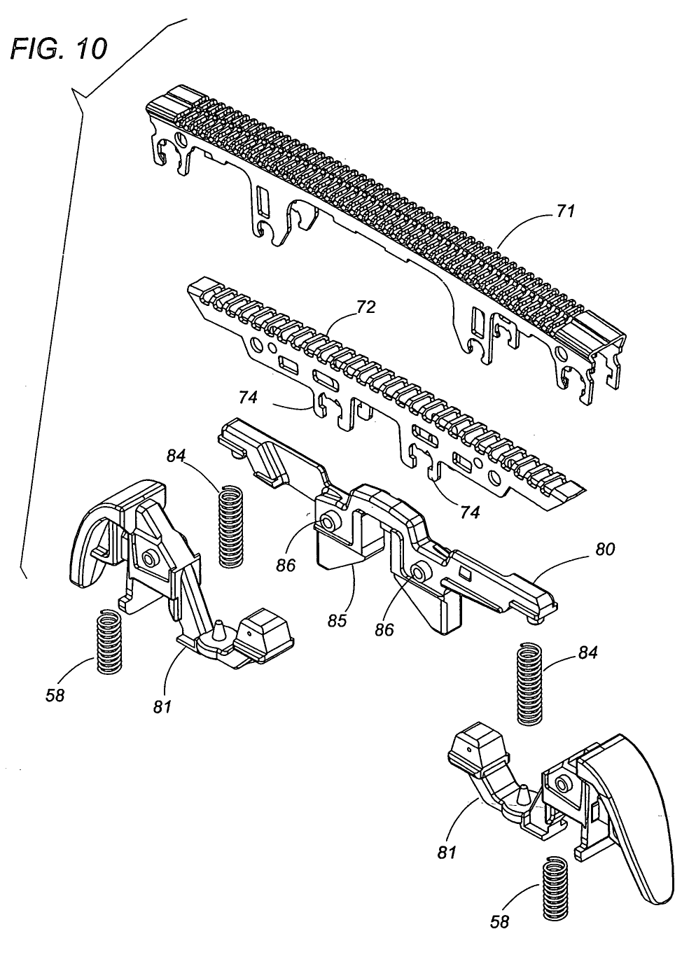

As shown in FIGS. 9 and 10, the slit cutter unit 70 includes a chassis which carries the outer slit cutter 71 and retains the inner cutter 72 in such a manner as to allow the reciprocating movement of the inner cutter 72 relative to the outer slit cutter 71. The chassis is composed of two end supports 81 which are secured to the opposite lengthwise ends of the outer slit cutter 71, respectively, and which support a coupler 80 carrying the inner cutter 72 by means of springs 84 such that the inner cutter 72 is movable relative to the outer slit cutter 71 with a suitable contact pressure therebetween. A finger 79 depends from the outer longitudinal ends of each end support 81 to in an overlapping relation with the hook 59. The coupler 80 is made of a plastic material and is formed at its center with a joint 85 for connection with the driving element, i.e., the pin 93 projecting on top of the cradle case 42. The coupler 80 is also formed with studs 86 which are mechanically engaged and heat-sealed to associated C-shaped hooks 74 on the side of the inner cutter 72 shaped from a metal sheet. Each of the end supports 81 is slidably received in center vertical slots 54 of the frame 51 and is secured to one of the cassettes 55 to be movable together therewith relative to the frame 51 or the cradle case 42, and is therefore allowed to be depressed or inclined with respect to a width axis of the cradle case 42. When the cutter holder 50 is attached to the cradle case 42, each outer foils 61 can be allowed to be independently depressed against a spring force acting on the inner cutter 62 by a spring 94 provided in each of the output elements 92 on the side of the cradle case 42. Further, the inner cutter 62 is swingably connected to the output element 92 such that each foil cutter unit 60 can be inclined in opposite directions, in addition to being depressed relative to the cradle case 42 in the like manner as the shaving head 40 does relative to the hand grip 10, which will be discussed in details hereinafter.

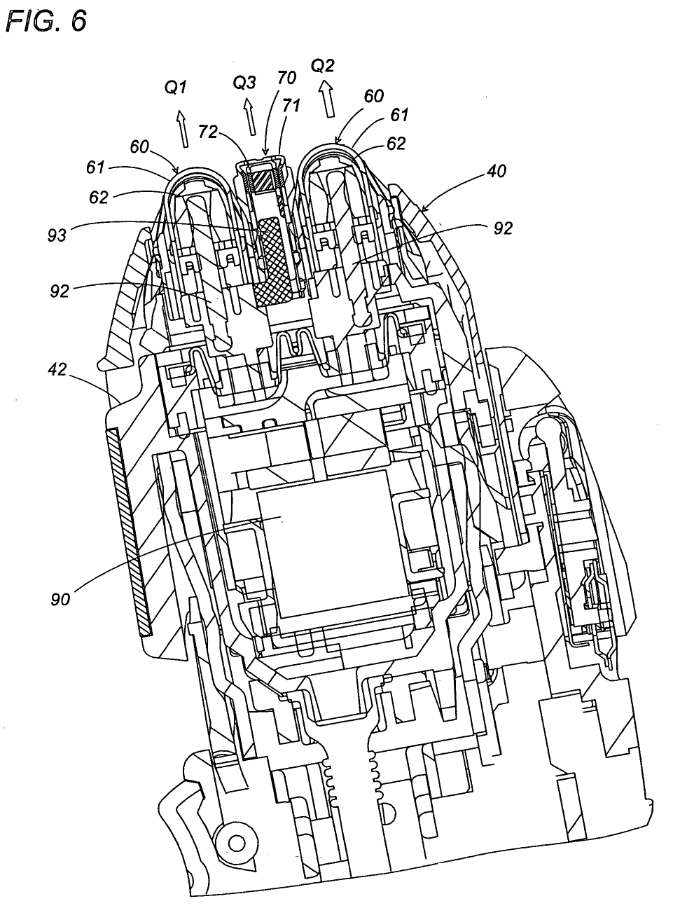

The end supports 81 are mounted to the frame 51 and are biased upwardly therefrom by longitudinally spaced springs 58 held between each end support 81 and each one of legs 57 projecting on the longitudinal ends of the cassettes 55 constituting the foil cutter unit 60 disposed at the front upper end of the shaving head 40. Thus, the slit cutter unit 70 is floatingly supported to the one cassette 55 so as to be capable of being depressed relative to the front cutter unit 60 against the biasing force Q3 of the springs 58. Basically, the front and rear foil cutter units 60 are biased upwardly respectively by means of the springs 94 of the same spring constant such that the foil cutter units 60 would be depressed against the same biasing forces Q2. However, because of the spring connection made by the springs 58 between the front foil cutter unit 60 and the slit cutter unit 70, the front foil cutter unit 60 receives the counter biasing force Q3 from the springs 84 so as to be depressed against the biasing force Q1 (=Q2−Q3), as indicated by arrows in FIG. 6. Therefore, the front cutter unit 60 is given the biasing force Q1 which is weaker than the biasing force Q2 for the rear foil cutter unit 60. The biasing force Q3 of the slit cutter unit 70 may be equal to or less than Q2 for the front foil cutter unit 60. The scheme of weakening the biasing force for the front foil cutter unit 60 than the rear one is advantageous particularly for the shaving head 40 inclined relative to the height axis of the grip 10. The shaving head 40 is inclined for the purpose of manipulating the shaver comfortably and easier to place the cutting face into optimum contact with the skin with less fatigue on the user's hand. There may be some situations in which the shaving head may be placed against the skin with the front foil cutter unit 60 coming first into contact with the skin, leaving the rear foil cutter unit away from the skin while moving the shaver head across the skin. However, the above scheme of differentiating the biasing forces is advantageous to place the front and rear foil cutter units 60 simultaneously into contact with the skin, since the front foil cutter unit 60 is depressed by a greater extent than the rear foil cutter unit as a consequence of the shaver head 10 being pressed against the skin.

The outer slit cutter 71 of the slit cutter unit 70 is curved arcuately with a radius of curvature greater than that of the outer foil 61 of the foil cutter unit 60 in order to come into contact with the skin over a wider range than the arcuately curved outer foil 61. Thus, the outer slit cutter 71 can bear the pressure applied against the skin over its length longer than the outer foil 61, thereby avoiding the adjacent outer foil 61 from being pressed excessively against the skin and therefore assuring a comfortable and efficient shaving at the foil cutter unit 60.

The shaving head 40 or the cutter holder 50 is rounded at its front, rear, and side faces. Particularly, the upper end of the cutter holder 50 or the shaving head 40 is rounded at a portion surrounding the foil cutter units 60 and the slit cutter unit 70 to give a rounded contour for smooth and non-irritating contact with the skin. The rounded contour is defined by the upper end of each cover 52 as well as the fingers 79 of the slit cutter unit 70. Each cover 52 has an outer surface defined by a metal coating and is formed at its longitudinal ends with shoulders 152 each of which is in flush at its one end with and in a closely adjacent relation to the longitudinal ends of the outer foil 61. The shoulder 152 is dimensioned to have a top face of about 2 mm to 5 mm×2 mm×5 mm, and is rounded at its corner away from the outer foil 61 and the slit cutter unit 70 to give a curved corner having a raidus of curvature of 2 mm to 10 mm. The side face of the cutter holder 50 is formed by the combination of the ends of the cover 52 and the finger 79. Further, each cover 52 is formed in its upper end surface with a frill 150 extending in closely adjacent relation with the periphery of the outer foil 61. The frill 150 including the shoulders 152 is finished to have minute smooth irregularities which give a nonglossy finish while retaining smooth sliding contact with the skin. The nonglossy finish can hide or make inconspicuous any scratch inevitably developed around the outer foil by repeated contact with the hairs during the long term use.

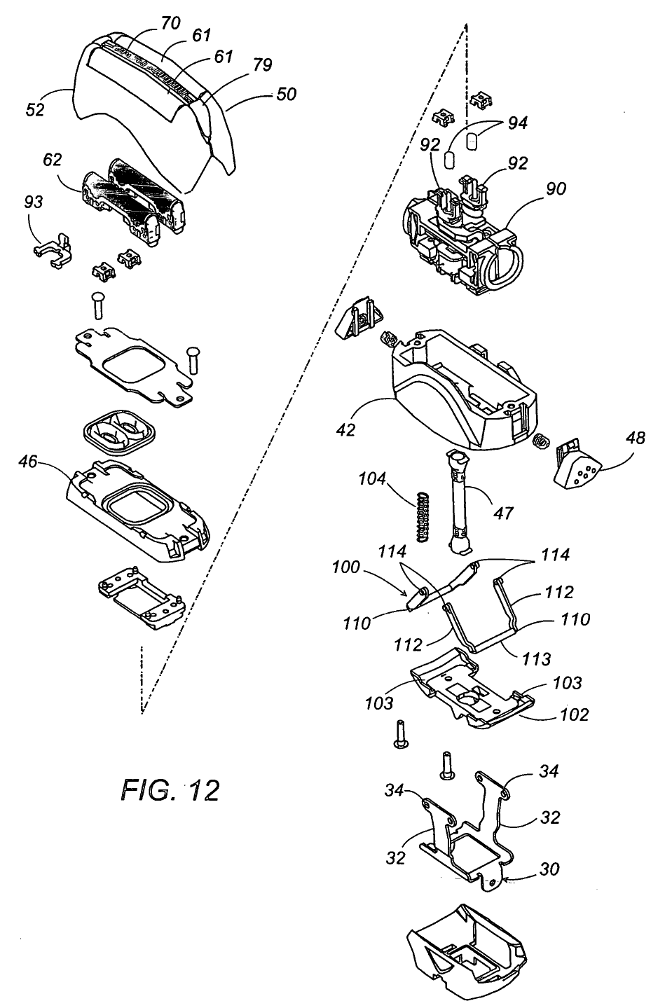

Now, the discussion is made to the swinging movement of the shaving head 40 relative to the grip 10. As shown in FIGS. 11 and 12, the linkage mechanism 100 responsible for the swinging movement includes a pair of U-shaped cranks 110 each having two side links 112 interconnected at their lower ends with a support axle 113. Each side link 112 is formed at its upper end with an anchor pin 114 which fits into a pivot hole 34 at the top end of the prop 32 of the frame 30 such that each of the cranks 110 can pivot about a horizontal axis at a connection to the upper end of the frame 30. The support axles 113 of the cranks 110 are fitted respectively into pivot grooves 103 in a backing seat 102 secured to the bottom of the case 42 such that such that each crank 110 can also pivot about a horizontal axis at the pivot connection to the lower end of the case 42. For better understanding of the swinging motion of the shaving head 40, the pivotal connections of the cranks 110 to the frame 30 are referred to as anchor points on the side of the grip 10, while the pivotal connection of the cranks 110 to the shaving head 40 are referred to as support points on the side of the shaving head 40.

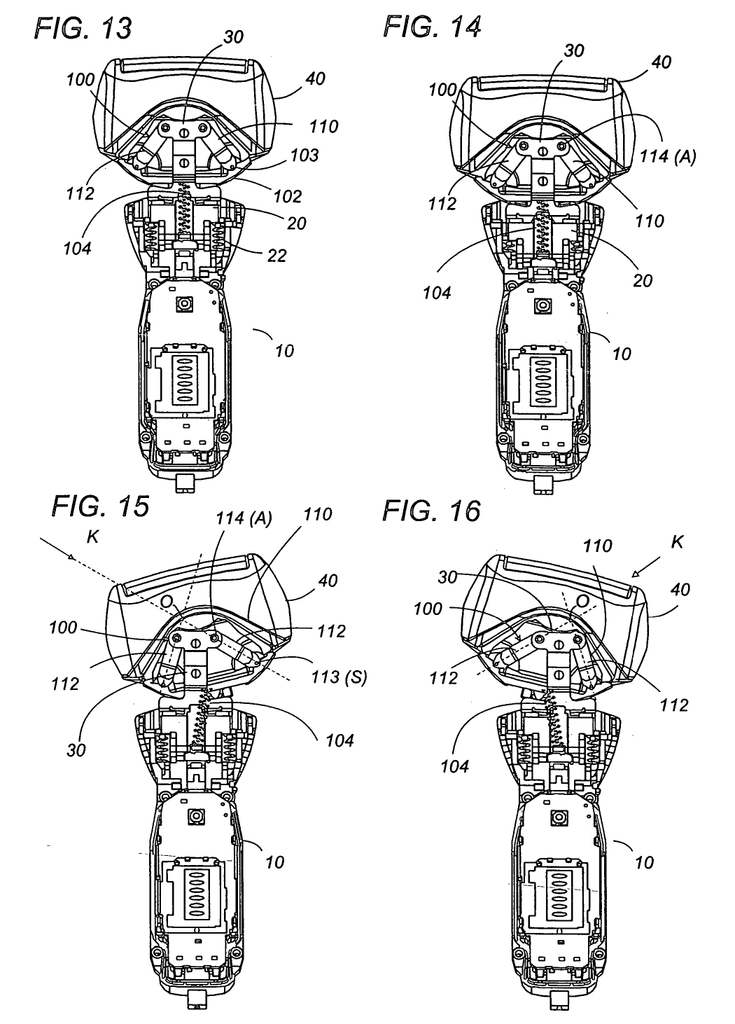

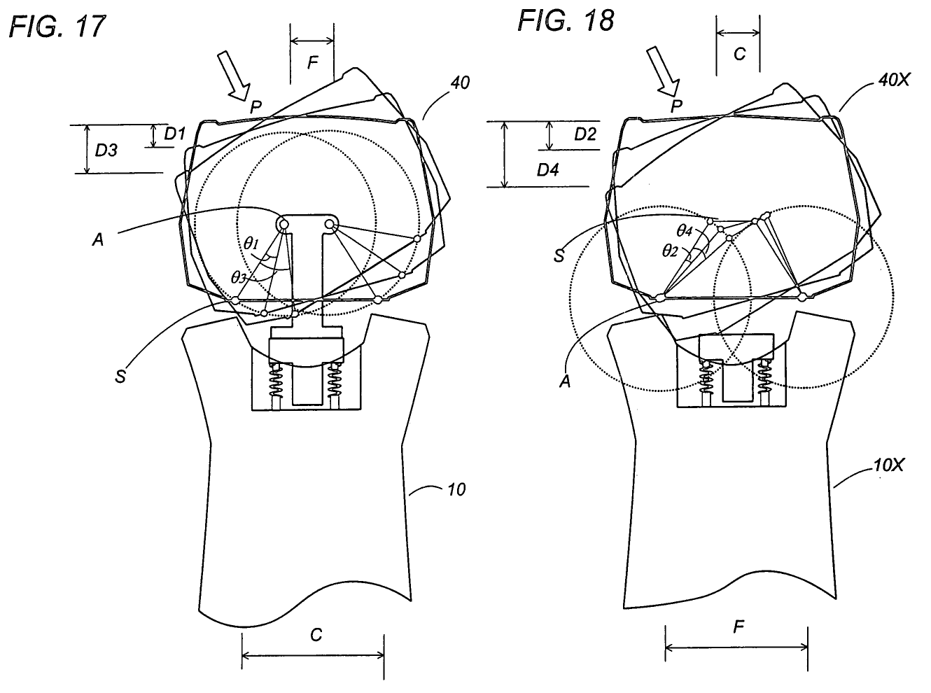

The two cranks 110 constitute a double-crank mechanism in which the upper end of the prop 32 gives a frame bar between the anchor points (A), and the bottom of the case 42 gives a coupler bar between the support points (S), and in which the frame bar (frame distance) (F) is shorter than the coupler bar (coupler distance) (C), as indicated in FIG. 17. Thus, the shaving head 40 is suspended from the frame 30 by means of the double-crank mechanism so as to be allowed to swing on top of the grip 10. A coil spring 104 interconnects the shaving head 40 and the slider 20 to give a spring bias against which the shaving head 40 swings relative to the grip 10, as shown in FIGS. 15 and 16. The coupler distance (C) is set to be at least 1.5 times the frame distance (F), and the cranks 110 are angled with each other at an angle of 300 to 1200 at an upright position of FIG. 13, i.e., a neutral position to which the shaving head 40 returns in the absence of an external force. The props 32 projecting from the upper end of the grip 10 in an overlapping relation with the shaving head 40 are received together with the side links 112 into corresponding slits formed in the front and rear faces of the case 42 to be concealed within the shaving head 40.

With the combination of the double-crank linkage mechanism and the floating mounting structure, the shaving head 40 can be simply depressed to a position of FIG. 14, and also can swing or tilt to either direction with or without being accompanied with the sinking movement, as shown in FIGS. 15 and 16, while the shaving head 40 is manipulated to move across the user's skin as being pressed against the skin. As seen in FIGS. 15 and 16, the above double-crank mechanism 100 gives an instantaneous pseudo swing center (O) at a crossing point of extension lines to the side links 112, which is located adjacent to the top cuffing face and about which the shaving head 40 swings. With this consequence, the shaving head 40 can be given a self-locking capability of ceasing a further swinging movement when a force K applied to shaving head along a direction aligned with the extension line of one side link 112 making a larger angular displacement.

Further, since the above double-crank mechanism 100 is specifically adapted to have the anchor points (A) located upwardly of the support points (S) with respect to the height axis of the grip 10, it gives a specific swinging motion to the shaving head 40 suitable to follow the skin only with a minimum of lateral and vertical displacement with regard to a point of contact with the skin and therefore to keep the contacting pressure at a suitable level. Such specific swinging motion can be well understood with reference to FIG. 17, in contrast to a possible implementation of FIG. 18 in which the support points (S) are located upwardly of the anchor points (A) for lifting the shaving head 40X on top of the grip 10X. For easy comparison between the swinging movement of the present invention of FIG. 17 and that of the possible implementation of FIG. 18, the shaving heads 40 and 40X are shown at the same inclinations.

Upon receiving a force at a contact point P as indicated by arrows in the figures, both of shaving heads 40 and 40X are caused to swing through the angular displacements of the cranks of the linkage mechanism. When the shaving head swings to a small extent, contact point P sees a vertical displacement D1 for the shaving head 40 of FIG. 17, while the contact point P of shaving head 40X of FIG. 18 sees a greater vertical displacement D2 (D2>D1). As the shaving heads further swing to a large extent, contact point P sees a vertical displacement D3 for the shaving head 40 of FIG. 17, while contact point P of shaving head 40X of FIG. 18 sees again a greater vertical displacement D4 (D4>D3). From this simple comparison, it is easily confirmed that the linkage mechanism of the present invention can minimize the vertical displacement of the contact point away from the skin during the swinging movement.

Also, when swinging to the same inclinations, the shaving head 40 of FIG. 17 is accompanied by angular displacements (θ1, θ3) of crank, which are considerably greater than the corresponding angular displacements (θ2, θ4) that the crank of the shaving head 40X of FIG. 18 makes (θ1>θ2, θ3>θ4). Thus, the shaving head 40 swings over a larger angle of the crank than the shaving head 40X with an attendant smoothness, i.e., without accompanied with an overshooting motion which would be otherwise seen for the shaving head 40×that swings only through smaller angular displacements (θ2, θ3) of the crank. Accordingly, the shaving head 40 can smoothly swing to a desired inclination without suffering from jerky and overshooting movement by use of the above linkage mechanism of suspending the shaving head 40 on top of the grip 10.

Further, it is easily confirmed by comparison of the diagrams of FIGS. 17 and 18, the shaving head 40 can swing over a wide range, while the shaving head 40X suffers from a dead point soon after the left-hand crank rotates beyond angle (θ4), where the left-hand crank becomes aligned with a coupler arm connecting the two support points (S) on the shaving head 40X to permit no further actual swinging movement. Thus, the above linkage mechanism allows the shaving head 40 to swing over a wide range without being jammed.

1. A dry shaver comprising:
a grip to be grasped by a user's hand
a shaving head being supported to said grip and carrying a foil cutter unit composed of an outer foil and an inner cutter driven to move relative to said outer foil in hair shearing engagement therewith;
said outer foil being elongated to have a length and a width, and being arcuately curved along its length,
characterized in that
said shaving head is movably supported to said grip so as to be tiltable about a transverse axis parallel to the width of said outer foil.

2. The dry shaver as set forth in claim 1, wherein
said shaving head accommodates therein a motor which drives said inner cutter.

3. The dry shaver as set forth in claim 1, wherein
said shaving head is floatingly supported to said grip to be capable of being depressed.

4. The dry shaver as set forth in claim 1, wherein
said shaving head is inclined with respect to a height axis of said grip to have a front upper end and a rear upper end at a lever higher than the front upper end, said shaving head carrying a pair of said foil cutter units spaced in its thickness direction with one of said foil cutter units held at the front upper end and the other foil cutter unit at the rear upper end,
said cutter unit at the front upper end being biased upwardly by a less spring bias than said cutter unit at the rear upper end.

5. The dry shaver as set forth in claim 4, wherein
said shaving head further includes a slit cutter unit composed of an outer slit cutter and an inner cutter, said slit cutter unit being interposed between said foil cutter units and is biased upwardly by a spring bias which is equal or less than that of the foil cutter unit at the front upper end of said shaving head.

6. The dry shaver as set forth in claim 1, wherein
said shaving head further includes a slit cutter unit composed of an outer slit cutter and an inner cutter,
said slit cutter unit being arranged in parallel with said foil cutter unit,
said outer slit cutter being arcuately curved along its length with a radius of curvature greater than that of the outer foil.

7. The dry shaver as set forth in claim 1, wherein
said shaving head is formed on its upper face with shoulders respectively in closely adjacent relation to the longitudinal ends of said outer foil for sliding contact with a user's skin;
each of said shoulders being rounded at its corner away from said outer foil to give a curved corner having a radius of curvature of 2 mm to 10 mm.

8. The dry shaver as set forth in claim 7, wherein
each of said shoulders is finished to have minute smooth irregularities.

9. The dry shaver as set forth in claim 7, wherein
said shaving head is formed in its top surface with a frill extending along the periphery of said outer foil, said frill including said shoulders and being finished to have minute smooth irregularities.

10. The dry shaver as set forth in claim 1, wherein
said shaving head is mounted on top of said grip with respect to a height axis of said grip, said shaving head having a pair of support points (S) through which said shaving head is supported to said grip;
said shaving head is coupled to said grip by means of a linkage mechanism which allows said shaving head to swing relative to said grip, said linkage mechanism including a pair of cranks each connected at its one end to each one of said support points and connected at the other end to each one of anchor points on the side of said grip;
a frame being provided to project on top of said grip in an overlapping relation with the shaving head to give said anchor points (A) which are positioned upwardly of the support point (S) with respect to the height axis of said grip for suspending said shaving head by said frame.
